(19) United States
(12) Patent Application Publication
(10) Pub. No.: US 2024/0070440 A1
(43) Pub. Date: Feb. 29, 2024

(54) MULTIMODAL REPRESENTATION LEARNING

(71) Applicant: Bayer Aktiengesellschaft, Leverkusen (DE)

(72) Inventors: Johannes HOEHNE, Oranienburg (DE); Steffen VOGLER, Berlin (DE); Matthias LENGA, Leverkusen (DE)

(73) Assignee: Bayer Aktiengesellschaft, Leverkusen (DE)

(21) Appl. No.: 18/280,160

(22) PCT Filed: Feb. 23, 2022
(86) PCT No.: PCT/EP2022/054471

§ 371 Date: Sep. 1, 2023

(30) Foreign Application Priority Data
Mar. 5, 2021 (EP) 21161044.9

(51) Int. Cl. G06N 3/0455

(52) U.S. Cl. CPC G06N 3/0455

(57) ABSTRACT

Systems, methods, and computer programs disclosed herein relate to training a machine learning model to generate multimodal representations of objects, and to the use of said representations for predictive purposes.

### CROSS REFERENCE TO RELATED APPLICATIONS

This application is a national stage application under 35 U.S.C. § 371 of International Application No. PCT/EP2022/054471, filed internationally on Feb. 23, 2022, which claims benefit of European Application No.: 21161044.9, filed Mar. 5, 2021.

### FIELD

Systems, methods, and computer programs disclosed herein relate to training a machine learning model to generate multimodal representations of objects, and to the use of said representations for predictive purposes.

### BACKGROUND

Information in the real world usually comes in different modalities. Modes are, essentially, channels of information. Image, text, and speech are examples of different modes. Videos, for example, typically have information in multiple modalities, for example audio (such as music, sound, speech, etc.), video (sequences of images), and text (e.g., subtitles).

Different modalities can be characterized by different properties. For instance, images are usually represented as pixel intensities or outputs of feature extractors, while texts can be represented, e.g., as discrete word count vectors.

Many models/algorithms have been implemented to retrieve and classify a certain type of data, e.g., images or text.

Multi-modal machine learning aims to build models that can process and relate information from multiple modalities. These data from multiple sources are semantically correlated and sometimes provide complementary information to each other, thus reflecting patterns that aren't visible when working exclusively with a single modality.

There are several publications dealing with multimodal representation learning which aims to narrow the heterogeneity gap among different modalities (see, e.g., W. Guo et al: Deep Multimodal Representation Learning: A Survey. IEEE Access. PP. 1-1. 10.1109/ACCESS.2019.2916887).

However, there is still need for improvement.

### SUMMARY

One aim of the present disclosure is to provide a solution for generating a multimodal representation of an object. Another aim of the present disclosure is to provide a solution for making a statement about information from one modality based on information from another modality. Another aim of the present disclosure is to provide a solution for assessing whether two sets of data of different modality characterize the same object or different objects.

Provided is a computer-implemented method of training a machine learning model, the method comprising:
receiving, for each object of a multitude of objects, input data of at least two different modalities, first input data of a first modality and second input data of a second modality,
generating first augmented input data from the first input data and second augmented input data from the second input data,
generating first masked input data from the first augmented input data and second masked input data from the second augmented input data,
providing a machine learning model, the machine learning model comprising
   a first input,
   a second input,
   a first output,
   a second output, and
   a third output,
training the machine learning model to perform a combined reconstruction and discrimination task, the training comprising:
   inputting the first masked input data into the first input,
   inputting the second masked input data into the second input,
   reconstructing the first augmented input data from the first masked input data via the first output,
   reconstructing the second augmented input data from the second masked input data via the second output,
   generating a joint representation of the first masked input data and the second masked input data via the third output, and
   discriminating joint representations which were generated from input data of the same object from joint contrastive representations which were generated from input data of different objects, and
storing and/or outputting the trained machine learning model and/or providing the trained machine learning model for predictive purposes.

Additionally, provided is a computer system comprising a processor and a memory storing an application program configured to perform, when executed by the processor, an operation, the operation comprising:
receiving, for each object of a multitude of objects, input data of at least two different modalities, first input data of a first modality and second input data of a second modality,
generating first augmented input data from the first input data and second augmented input data from the second input data,
generating first masked input data from the first augmented input data and second masked input data from the second augmented input data,
providing a machine learning model, the machine learning model comprising
   a first input,
   a second input,
   a first output,
   a second output, and
   a third output,
training the machine learning model to perform a combined reconstruction and discrimination task, the training comprising:
   inputting the first masked input data into the first input,
   inputting the second masked input data into the second input,
   reconstructing the first augmented input data from the first masked input data via the first output,
   reconstructing the second augmented input data from the second masked input data via the second output,
   generating a joint representation of the first masked input data and the second masked input data via the third output, and
   discriminating joint representations which were generated from input data of the same object from joint contrastive representations which were generated from input data of different objects, and
storing and/or outputting the trained machine learning model and/or providing the trained machine learning model for predictive purposes.

Furthermore, provided is a non-transitory computer readable medium storing software instructions that, when executed by a processor of a computer system, cause the computer system to:
receive, for each object of a multitude of objects, input data of at least two different modalities, first input data of a first modality and second input data of a second modality,
generate first augmented input data from the first input data and second augmented input data from the second input data,
generate first masked input data from the first augmented input data and second masked input data from the second augmented input data,
provide a machine learning model, the machine learning model comprising
   a first input,
   a second input,
   a first output,
   a second output, and
   a third output,
train the machine learning model to perform a combined reconstruction and discrimination task, the training comprising:
   inputting the first masked input data into the first input,
   inputting the second masked input data into the second input,
   reconstructing the first augmented input data from the first masked input data via the first output,
   reconstructing the second augmented input data from the second masked input data via the second output,
   generating a joint representation of the first masked input data and the second masked input data via the third output, and
   discriminating joint representations which were generated from input data of the same object from joint contrastive representations which were generated from input data of different objects, and
store and/or outputting the trained machine learning model and/or providing the trained machine learning model for predictive purposes.

### BRIEF DESCRIPTION OF THE FIGURES

The invention will be described, by way of example only, with reference to the following figures.

FIG. 1 shows an example of how augmented data and masked data are created for data characterizing three different objects: a cube, a cylinder, and a tetrahedron.

FIG. 2 shows another example of how augmented data and masked data are created for data characterizing three different objects: a cube, a cylinder, and a tetrahedron.

FIG. 3 shows the architecture of a deep neural network, according to some embodiments.

FIG. 4 shows a classifier, according to some embodiments.

FIG. 5 shows a computer system, according to some embodiments.

### DETAILED DESCRIPTION

The different aspects of the present disclosure will be more particularly elucidated below without distinguishing between the aspects (method, computer system, computer readable medium). On the contrary, the following elucidations are intended to apply analogously to all aspects, irrespective of in which context (method, computer system, computer readable medium) they occur.

If steps are stated in an order in the specification of in the claims, this does not necessarily mean that the present disclosure is restricted to the stated order. On the contrary, it is conceivable that the steps can also be executed in a different order or else in parallel to one another, unless one step builds upon another step, this absolutely requiring that the building step be executed subsequently (this being, however, clear in the individual case). The stated orders are thus preferred embodiments of the present disclosure.

As used herein, the articles “a” and “an” are intended to include one or more items and may be used interchangeably with “one or more” and “at least one.” As used in the specification and the claims, the singular form of “a”, “an”, and “the” include plural referents, unless the context clearly dictates otherwise. Where only one item is intended, the term “one” or similar language is used. Also, as used herein, the terms “has”, “have”, “having”, or the like are intended to be open-ended terms. Further, the phrase “based on” is intended to mean “based at least partially on” unless explicitly stated otherwise. Further, the phrase “based on” may mean “in response to” and be indicative of a condition for automatically triggering a specified operation of an electronic device (e.g., a controller, a processor, a computing device, etc.) as appropriately referred to herein.

Some implementations of the present disclosure will be described more fully hereinafter with reference to the accompanying drawings, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art.

The present disclosure provides means for the generation of a multimodal representation of an object.

An “object” according to the present disclosure can be anything that is characterized by and/or can be described by one or more features. An object can, e.g., be a visible and/or tangible thing, or a living organism or a part thereof. An object can also be a virtual or artificial object (like a construction drawing or a model of a real object) or a virtual or artificial creature (like an avatar).

In a preferred embodiment of the present disclosure, the object is a human being (a person), preferably a patient.

In another preferred embodiment of the present disclosure, the object is an animal.

In another preferred embodiment of the present disclosure, the object is a plant (e.g., a crop) or a plurality of plants (e.g., plants (crops) in an agricultural field).

In another preferred embodiment of the present disclosure, the object is a part of the Earth's surface.

In another preferred embodiment of the present disclosure, the object is a machine, such as a car, or a train, or an airplane, or a part thereof such as a motor or a power unit or an electronic circuit, or a semiconductor topography, or a city model, or a building, or the like.

The object can be characterized by certain features. In case of a human being, such features can include age, height, weight, gender, eye color, hair color, skin color, blood group, existing illnesses or conditions, pre-existing conditions, and/or the like. An image showing the body of the human being or a part thereof is an example of a collection of features characterizing the human being.

Features of an object can be described and/or recorded (captured) in various ways, or technically expressed, in different modalities.

For example, the outcome of a pregnancy test can be represented by a picture of the test unit with a certain color indicating the test result or, alternatively, can be represented by a line of text saying “This person is pregnant”. The outcome of a pregnancy test may also be a circle with a check mark in it at a certain position of a structured form or, alternatively, a 1 as opposed to a 0 in the memory of a computer, electronic device, server, or the like. All these data comprise the same information but in the form of different representations/modalities.

According to the present disclosure, features characterizing an object are present in at least two modalities, such as one or more images, texts, numbers, audio files, video files, and/or the like. Note that some features of the object may be contained in one modality only. Also, the modalities could carry conflicting information about the object.

From one or more features of a certain modality, a set of input data is generated. Input data are representations of one or more features of an object in a format which allows usage of the input data for machine learning purposes. The input data can, e.g., be in the format of a feature vector.

In machine learning, a feature vector is an n-dimensional vector of numerical features that represent an object, wherein n is an integer greater than 0. Many algorithms in machine learning require a numerical representation of objects, since such representations facilitate processing and statistical analysis. When representing images, the feature values might correspond to the pixels/voxels of an image, while when representing texts, the features might be the frequencies of occurrence of textual terms.

Examples of feature vector generation methods can be found in various textbooks and scientific publications (see, e.g., G. A. Tsihrintzis, L. C. Jain: Machine Learning Paradigms: Advances in Deep Learning-based Technological Applications, in: Learning and Analytics in Intelligent Systems Vol. 18, Springer Nature, 2020, ISBN: 9783030497248; K. Grzegorczyk: Vector representations of text data in deep learning, Doctoral Dissertation, 2018, arXiv:1901.01695v1).

According to the present disclosure, at least two sets of input data of different modalities are used to generate a multimodal representation of an object.

In other words: the at least two sets of input data comprise first input data of a first modality and second input data of a second modality.

It is possible that the at least two sets of input data additionally comprise third input data, wherein the third input data can be data of the first modality, the second modality, or a third modality, the third modality being different from the first and the second modality. It is also possible, that the at least two sets of input data additionally comprise fourth input data, wherein the fourth input data can be data of the first modality, the second modality, the third modality, or a fourth modality, the fourth modality being different from the first, the second and the third modality. And so forth.

Input data can be or comprise one or more images and/or input data can originate from one or more images.

The term “image” as used herein means a data structure that represents a spatial distribution of a physical signal. The spatial distribution may be of any dimension, for example 2D, 3D, 4D, or any higher dimension. The spatial distribution may be of any shape, for example forming a grid and thereby defining pixels, the grid being possibly irregular or regular. The physical signal may be any signal, for example proton density, tissue echogenicity, measurements related to the blood flow, information of rotating hydrogen nuclei in a magnetic field, color, level of gray, depth, surface or volume occupancy, such that the image may be a 2D or 3D RGB/grayscale/depth image, or a 3D surface/volume occupancy model. The image may be a synthetic image, such as a designed 3D modeled object, or alternatively a natural image, such as a photo or frame from a video.

In a preferred embodiment of the present disclosure, input data comprise a 2D and/or 3D medical image.

A medical image is a visual representation of the human body or a part thereof or of the body of an animal or a part thereof. Medical images can be used, e.g., for diagnostic and/or treatment purposes.

Techniques for generating medical images include X-ray radiography, computerized tomography, fluoroscopy, magnetic resonance imaging, ultrasonography, endoscopy, elastography, tactile imaging, thermography, microscopy, positron emission tomography and others.

Examples of medical images include CT (computer tomography) scans, X-ray images, MRI (magnetic resonance imaging) scans, fluorescein angiography images, OCT (optical coherence tomography) scans, histopathological images, ultrasound images and others.

A widely used format for digital medical images is the DICOM format (DICOM: Digital Imaging and Communications in Medicine).

In another preferred embodiment of the present disclosure, input data comprise an image (such as a photography) of one or more plants (e.g., crops) or parts thereof. A photography is an image taken by a camera (including hyperspectral cameras), such camera comprising a sensor for imaging an object with the help of electromagnetic radiation. The image can, e.g., show one or more plants or parts thereof (e.g., one or more leaves) infected by a certain disease (such as for example a fungal disease) or infested by a pest (such as for example a caterpillar, a nematode, a beetle, a snail or any other organism that can lead to plant damage).

In another preferred embodiment of the present disclosure, input data comprise an image of a part of the Earth's surface, such as an agricultural field, taken from a satellite or an airplane (manned or unmanned aerial vehicle) or combinations thereof (remote sensing data/imagery).

“Remote sensing” means the acquisition of information about an object or phenomenon without making physical contact with the object and thus is in contrast to on-site observation. The term is used especially for obtaining information about the Earth. Remote sensing is used in numerous fields, including geography, land surveying and most Earth science disciplines (for example, hydrology, ecology, meteorology, oceanography, glaciology, geology, etc.).

In particular, the term “remote sensing” refers to the use of satellite or aircraft-based sensor technologies to detect and classify objects on Earth. It includes the surface and the atmosphere and oceans, based on propagated signals (e.g., electromagnetic radiation). It may be split into “active” remote sensing (when a signal is emitted by a satellite or aircraft to the object and its reflection detected by the sensor) and “passive” remote sensing (when the reflection of sunlight is detected by the sensor).

Details about remote sensing data/imagery can be found in various publications (see, e.g., N. Fareed: Intelligent High Resolution Satellite/Aerial Imagery; Advances in Remote Sensing, 2014, 03. 1-9. 10.4236/ars.2014.31001; C. Yang et al.: Using High-Resolution Airborne and Satellite Imagery to Assess Crop Growth and Yield Variability for Precision Agriculture, in Proceedings of the IEEE, vol. 101, no. 3, pp. 582-592, March 2013, doi: 10.1109/JPROC.2012.2196249; P. Basnyat et al.: Agriculture field characterization using aerial photograph and satellite imagery, in IEEE Geoscience and Remote Sensing Letters, vol. 1, no. 1, pp. 7-10, January 2004, doi: 10.1109/LGRS.2003.822313; WO2018/140225; WO2020/132674; WO2019/217152).

Input data can be or comprise one or more texts and/or input data can originate from one or more texts.

A “text” is a (written) fixed, thematically related sequence of statements. A text can comprise words and/or numbers, the words usually being made up of letters of an alphabet (e.g., the Latin alphabet). The term “text” also includes tables and spreadsheets.

The text is preferably present as a digital text file (such as an ASCII-file or XML-file). A text which is not present as a digital text file can be converted into a digital text file by well-known conversion tools. For example, a letter or a telefax can be scanned using a flatbed scanner or photographed using a digital camera and the resulting image file can then be analyzed by optical character recognition (OCR) technology in order to identify characters in the scanned copy and convert the scanned copy into a digital text file. For example, a voice message can be recorded as a digital audio file (such as a WAV-file) and speech-to-text technology can be used in order to convert the audio file into a digital text file.

Text input data may for instance comprise information about some aspect of a human's health. To name a few non-limiting examples, this information can pertain to an internal body parameter such as blood type, blood pressure, resting heart rate, heart rate variability, vagus nerve tone, hematocrit, sugar concentration in urine, or a combination thereof. It can describe an external body parameter such as height, weight, age, body mass index, eyesight, or another parameter of the patient's physique. Further exemplary pieces of health information comprised (e.g., contained) in text input data may be medical intervention parameters such as regular medication, occasional medication, or other previous or current medical interventions and/or other information about the patient's previous and current treatments and reported health conditions. Text input data may for example comprise lifestyle information about the life of the patient, such as consumption of alcohol, smoking, and/or exercise and/or the patient's diet. The (text) input data is of course not limited to physically measurable pieces of information and may for example further comprise psychological tests and diagnoses and similar information about the mental health. In another example, text input data may comprise at least parts of at least one previous opinion by a treating medical practitioner on certain aspects of the patient's health. Text input data may in addition or in the alternative comprise (e.g., contain) references and/or descriptions of other sources of medical data such as other text data and/or data of other modalities such as images acquired by a medical imaging technique, graphs created during a test and/or combinations thereof.

In one example, text input data may at least partly represent an EMR (electronic medical record) of a patient, or a part of it, also referred to as EHR (electronic health record). An EMR can, for example, comprise information about the patient's health such as one of the different pieces of information listed in the last paragraph. It is not necessary that every information in the EMR relates to the patient's body. For instance, information may for example pertain to the previous medical practitioner(s) who had contact with the patient and/or some data about the patient, assessed their health state, decided and/or carried out certain tests, operations and/or diagnoses. The EMR can comprise information about a hospital's or doctor's practice at which the patient obtained certain treatments and/or underwent certain tests, as well as various other meta-information about the treatments, medications, tests and the body-related and/or mental-health-related information of the patient. An EMR can for example comprise (e.g., include) personal information about the patient. An EMR may also be anonymized so that the medical description of a defined, but personally un-identifiable patient is provided. In some examples, the EMR contains at least a part of the patient's medical history.

In one example, text input data may at least partially represent information about a person's condition obtained from the person himself/herself (self-assessment data). Besides objectively acquired anatomical, physiological and/or physical data, the well-being of the patient also plays an important role in the monitoring of health. Subjective feeling can also make a considerable contribution to the understanding of objectively acquired data and of the correlation between various data. If, for example, it is captured by sensors that a person has experienced a physical strain, for example because the respiratory rate and the heart rate have risen, this may be because just low levels of physical exertion in everyday life place a strain on the person; however, another possibility is that the person consciously and gladly brought about the situation of physical strain, for example as part of a sporting activity. A self-assessment can provide clarity here about the causes of physiological features. For example, the issue of self-assessment plays an important role in clinical studies as well. In the English-language literature, the term “Patient Reported Outcomes” (abbreviation: PRO) is used as an umbrella term for many different concepts for measuring subjectively felt health statuses. The common basis of said concepts is that patient status is personally assessed and reported by the patient. Subjective feeling is collected by use of a self-assessment unit, with the aid of which the patient can record information about subjective health status. Preference is given to a list of questions which are to be answered by a patient. Preferably, the questions are answered with the aid of a computer (e.g., a tablet computer or a smartphone). One possibility is that the patient has questions displayed on a screen and/or read out via a speaker. One possibility is that the patient inputs the questions into a computer by inputting text via an input device (e.g., keyboard, mouse, touchscreen and/or a microphone (by means of speech input)). It is conceivable that a chatbot is used in order to facilitate the input of all items of information for the patient. It is conceivable that the questions are recurring questions which are to be answered once or more than once a day by a patient. It is conceivable that some of the questions are asked in response to a defined event. It is, for example, conceivable that it is captured by means of a sensor that a physiological parameter is outside a defined range (e.g., an increased respiratory rate is established). As a response to this event, the patient can, for example, receive a message via his/her smartphone or a smartwatch or the like that a defined event has occurred and that said patient should please answer one or more questions, for example in order to find out the causes and/or the accompanying circumstances in relation to the event. The questions can be of a psychometric nature and/or preference-based. At the heart of the psychometric approach is the description of the external, internal and anticipated experiences of the individual, by the individual. Said experiences can be based on the presence, the frequency and the intensity of symptoms, behaviors, capabilities or feelings of the individual questioned. The preference-based approach measures the value which patients assign to a health status.

Input data can be or comprise one or more captured sounds and/or input data can originate from sound.

“Sounds” are pressure variations in the air (or any other medium) that can be converted into an electrical signal with the help of a microphone and recorded mechanically or digitally. Other terms that are used for the term “sound” are “acoustic wave(s)” and “sound wave(s)”, which indicate that the pressure variations propagate through a transmission medium such as air. Sounds can be captured as an audio recording.

An “audio recording” is a representation of one or more sounds that can be used to analyze and/or reproduce the one or more sounds. In other words: sound can be captured in an audio recording so that it can be analyzed and/or played back as often as required at a later point in time and/or at another location.

The term “audio” indicates that the sound is usually a pressure variation that is within a range that is audible to (can be heard by) the human ear. The human hearing range is commonly given as 20 to 20,000 Hz, although there is considerable variation between individuals. However, the term “audio” should not be understood to mean that the methods described herein are limited to sound waves in the range of 20 to 20,000 Hz. In principle, the methods presented here can also be applied to sound waves that are outside the range perceived by humans.

Preferably, the sound was produced (willingly or unintentionally, consciously or unconsciously) by the object or by interaction of the object with its environment and/or with another object.

In a preferred embodiment, the sound is caused by a body action such as cough, snoring, sneezing, hiccups, vomiting, shouting, swallowing, wheezing, shortness of breath, chewing, teeth grinding, voice, and/or the like. In case of the object being a human being, the sound can be or comprise heartbeat, breathing noise, cough, swallow, sneeze, clear throat, scratch, voice, noises when knocking against part(s) of the body, joint noise, and/or other sounds and/or combinations thereof.

Input data can be or comprise and/or originate from one or more electromyographic signals, electrocardiogram signals, accelerometer signals, chest impedance signals, plethysmographic signals, temperature signals, heart rate signals, blood pressure signals and/or the like.

Input data can comprise information about weather, climate, soil properties, crops, agricultural fields and/or the like.

In a first step, input data of at least two different modalities, first input data of a first modality and second input data of a second modality, are received for a multitude of objects. The term “multitude” preferably means more than 10, more preferably more than 100. In other words, for each object of the multitude of objects two input data sets are received: i) a first input data set of a first modality and ii) a second input data set of a second modality. For each object, the two input data sets comprise data which characterize the respective object. In other words: for each object there is a pair of corresponding data sets: a first input data set of a first modality and a second input data set of a second modality.

From input data, augmented data is generated: from the first input data, first augmented input data are generated; from the second input data, second augmented input data are generated. Augmented input data are generated by applying one or more augmentation techniques to the input data.

The term “data augmentation” refers to modification techniques used to increase the amount of data by adding slightly modified copies of already existing data or newly created synthetic data from existing data.

From each input data set at least two augmented data sets are generated: from the first input data, at least two sets of first augmented input data are generated; from the second input data, at least two sets of second augmented input data are generated. The number of augmented input data sets per set of input data is usually between 2 and 5, however, the number can also be greater than 5.

Augmentation techniques used for image augmentation include geometric transformations, color space augmentations, kernel filters, mixing images, random erasing, feature space augmentation, adversarial training, generative adversarial networks, neural style transfer, and meta-learning.

Augmentation techniques used for text augmentation include replacement of words and/or phrases by synonyms, semantic similarity augmentation, round-trip translations, mix-up augmentation, random insertions, random swap, and random deletions.

Augmentation techniques used for audio augmentation include noise injection, time shifting, pitch change, speed change, mix-up, cutouts and/or random erasing in the audio spectrum, and vocal track length perturbation.

The first augmented input data are generated by applying one or more augmentation techniques to the first input data. The second augmented input data are generated by applying one or more augmentation techniques to the second input data.

In case of images as input data, augmented images are preferably generated by applying one or more spatial augmentation techniques to the images. Examples of spatial augmentation techniques include rigid transformations, non-rigid transformations, affine transformations and non-affine transformations.

A rigid transformation does not change the size or shape of the image. Examples of rigid transformations include reflection, rotation, and translation.

A non-rigid transformation can change the size or shape, or both size and shape, of the image. Examples of non-rigid transformations include dilation and shear.

An affine transformation is a geometric transformation that preserves lines and parallelism, but not necessarily distances and angles. Examples of affine transformations include translation, scaling, homothety, similarity, reflection, rotation, shear mapping, and compositions of them in any combination and sequence.

Preferably, the one or more spatial augmentation techniques applied to images include rotation, elastic deformation, flipping, scaling, stretching, shearing, cropping, resizing and/or combinations thereof.

In a preferred embodiment, one or more of the following spatial augmentation techniques is applied to images: rotation, elastic deformation, flipping, scaling, stretching, shearing, wherein the one or more spatial augmentation techniques are preferably followed by cropping and resizing.

Image augmentation techniques are described in more detail in various publications. The following list is just a small excerpt:
Rotation: D. Itzkovich et al.: “Using Augmentation to Improve the Robustness to Rotation of Deep Learning Segmentation in Robotic-Assisted Surgical Data,” 2019 International Conference on Robotics and Automation (ICRA), Montreal, QC, Canada, 2019, pp. 5068-5075, doi: 10.1109/ICRA.2019.8793963.
Elastic deformation: E. Castro et al.: “Elastic deformations for data augmentation in breast cancer mass detection”, 2018 IEEE EMBS International Conference on Biomedical Health Informatics (BHI), pp. 230-234, 2018.
Flipping: Y.-J. Cha et al.: Autonomous Structural Visual Inspection Using Region-Based Deep Learning for Detecting Multiple Damage Types, Computer-Aided Civil and Infrastructure Engineering, 00, 1-17. 10.1111/mice.12334.
Scaling: S. Wang et al.: Multiple Sclerosis Identification by 14-Layer Convolutional Neural Network With Batch Normalization, Dropout, and Stochastic Pooling, Frontiers in Neuroscience, 12. 818. 10.3389/fnins.2018.00818.
Stretching: Z. Wang et al.: CNN Training with Twenty Samples for Crack Detection via Data Augmentation, Sensors 2020, 20, 4849.
Shearing: B. Hu et al.: A Preliminary Study on Data Augmentation of Deep Learning for Image Classification, Computer Vision and Pattern Recognition; Machine Learning (cs.LG); Image and Video Processing (eess.IV), arXiv: 1906.11887.
Cropping and Resizing R. Takahashi et al.: Data Augmentation using Random Image Cropping and Patching for Deep CNNs, Journal of Latex Class Files, Vol. 14, No. 8, 2015, arXiv:1811.09030.
Cutout: T. DeVries and G. W. Taylor: Improved Regularization of Convolutional Neural Networks with Cutout, arXiv:1708.04552, 2017.
Erasing: Z. Zhong et al.: Random Erasing Data Augmentation, arXiv:1708.04896, 2017.

In case of text as input data, augmented text data are commonly generated by adding and/or replacing and/or removing content (e.g., letters, numbers, words, tokens, and/or phrases). In the context of electronic health records, a common practice to add missing information is to iteratively inputting incomplete variables by regressing on the remaining observations—also referred to as Multiple Imputation by Chained Equations (MICE). For details see, e.g., S. M. Meystre et al.: Extracting information from textual documents in the electronic health record: a review of recent research, Yearb Med Inform. 2008:128-44. PMID: 18660887; 0. Sun: MICE-DA: A MICE method with Data Augmentation for missing data imputation in IEEE ICHI 2019 DACMI Challenge, 2019 IEEE International Conference on Healthcare Informatics (ICHI) (2019): 1-3.

Further Text augmentation techniques are described in more detail in various publications. The following list is just a small excerpt:
V. Marivate, T. Sefara: Improving Short Text Classification Through Global Augmentation Methods, in: A. Holzinger et al. (eds): Machine Learning and Knowledge Extraction. CD-MAKE 2020. Lecture Notes in Computer Science, 2020, Vol. 12279. Springer, https://doi.org/10.1007/978-3-030-57321-8_21.
J. Wei, K. Zou: EDA: Easy Data Augmentation Techniques for Boosting Performance on Text Classification Tasks, arXiv:1901.11196 [cs.CL].
M. Abulaish, A. K. Sah: A Text Data Augmentation Approach for Improving the Performance of CNN” 2019, 11th International Conference on Communication Systems & Networks
(COMSNETS), Bengaluru, India, 2019, pp. 625-630, doi: 10.1109/COMSNETS.2019.8711054.
A. Ollagnier, H. Williams: Text Augmentation Techniques for Clinical Case Classification, 2020, https://www.researchgate.net/publication/343949092.
L. Nanni et al.: An Ensemble of Convolutional Neural Networks for Audio Classification, Appl. Sci. 2021, 11, 5796, https://doi.org/10.3390/app11135796.

In a further step, masked input data are generated from the augmented input data. Specifically, from the first augmented input data, first masked input data are generated, and from the second augmented input data, second masked input data are generated. Usually, from each set of augmented data, one set of masked input data is generated.

The term “masking” refers to techniques which hide parts of the data or features (values of features) represented by data. In case of images, one or more pixels or regions of pixels can be set to a specific value (such as 0) or to (a) random value(s). In case of texts, one or more letters, words or phrases can be deleted or replaced by a specific letter, word or phrase. It is also possible that the values of the pixels in a certain region of an image are shuffled or that the letters of a word or a phrase or that words/phrases in a text are shuffled.

Augmentation and/or masking operations may be performed on the respective input data and the resulting augmented input data and/or masked input data may then be stored on a non-transitory computer-readable storage medium for later training purposes. However, it is also possible to generate augmented input data and/or masked input data “in-memory” such that the augmented input data and/or masked input data may be generated temporarily and directly used for training purposes without storing the augmented input data and/or masked input data in a non-volatile storage medium.

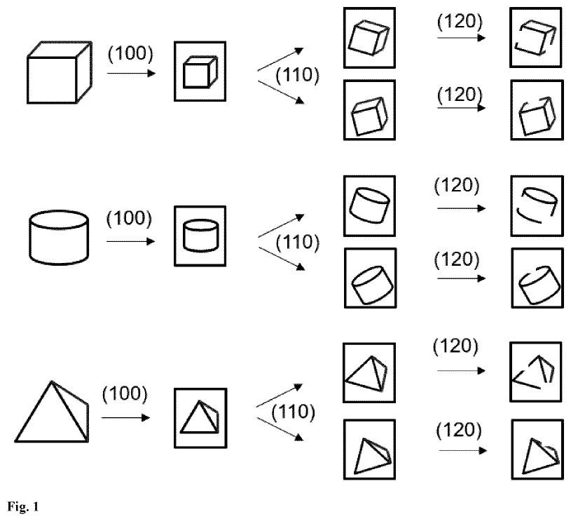

FIG. 1 shows schematically, by way of example, how augmented data and masked data are created for data characterizing three different objects, a cube, a cylinder and a tetrahedron. For each object input data representing the respective object are received (100). From each set of input data two (or more) sets of augmented input data are generated (110). From each set of augmented data, a set of masked input data is generated (120). In case of the example shown in FIG. 1, the input data representing an object is an image of the object; augmentation is done by rotating the imaged objects; masking is done by cutting out regions of the images.

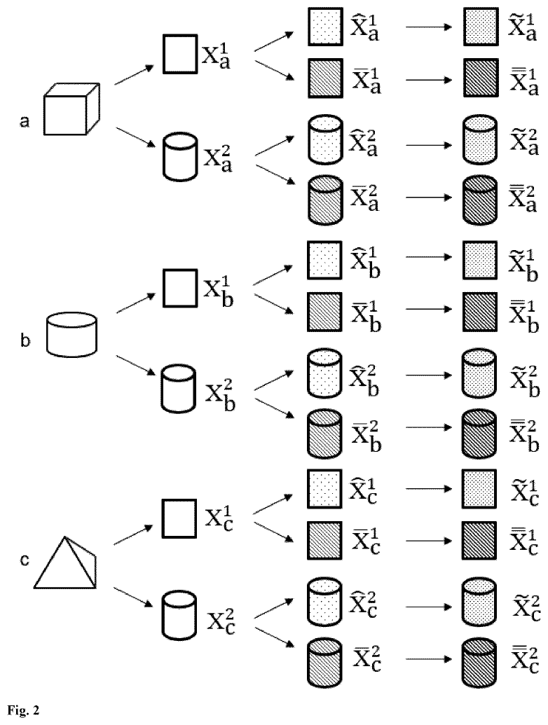

FIG. 2 shows schematically, by way of another example, how augmented data and masked data are created for data characterizing three different objects, a cube a, a cylinder b, and a tetrahedron c. For each object i (i=a, b, or c), input data of at least two different modalities (1 and 2) are received: first input data Xᵢ¹ of a modality 1 and second input data Xᵢ² of a modality 2. From each set of input data two sets of augmented input data are generated. From first input data Xᵢ¹ of modality 1, two sets of first augmented input data \hat{X}ᵢ¹ and X̅ᵢ¹ are generated; from second input data Xᵢ² of modality 2, two sets of second augmented input data \hat{X}ᵢ² and X̅ᵢ² are generated. From each set of augmented input data, masked input data are generated. From augmented input data \hat{X}ᵢ¹, masked input data \tilde{X}ᵢ¹ are generated, from augmented input data X̅ᵢ¹, masked input data X̅ᵢ¹ are generated; from augmented input data \hat{X}ᵢ², masked input data \tilde{X}ᵢ² are generated, from augmented input data X̅ᵢ², masked input data X̅ᵢ² are generated.

The resulting augmented input data, and masked input data are used for training a machine learning model.

Such a machine learning model, as described herein, may be understood as a computer implemented data processing architecture. The machine learning model can receive input data and provide output data based on that input data and the machine learning model, in particular the parameters of the machine learning model. The machine learning model can learn a relation between input data and output data through training. In training, parameters of the machine learning model may be adjusted in order to provide a desired output for a given input.

The process of training a machine learning model involves providing a machine learning algorithm (that is the learning algorithm) with training data to learn from. The term trained machine learning model refers to the model artifact that is created by the training process. The training data must contain the correct answer, which is referred to as the target. The learning algorithm finds patterns in the training data that map input data to the target, and it outputs a trained machine learning model that captures these patterns.

In the training process, training data are inputted into the machine learning model and the machine learning model generates an output. The output is compared with the (known) target. Parameters of the machine learning model are modified in order to reduce the deviations between the output and the (known) target to a (defined) minimum.

In general, a loss function can be used for training to evaluate the machine learning model. For example, a loss function can include a metric of comparison of the output and the target. The loss function may be chosen in such a way that it rewards a wanted relation between output and target and/or penalizes an unwanted relation between an output and a target. Such a relation can be, e.g., a similarity, or a dissimilarity, or another relation.

A loss function can be used to calculate a loss value for a given pair of output and target. The aim of the training process can be to modify (adjust) parameters of the machine learning model in order to reduce the loss value to a (defined) minimum.

A loss function may for example quantify the deviation between the output of the machine learning model for a given input and the target. If, for example, the output and the target are numbers, the loss function could be the difference between these numbers, or alternatively the absolute value of the difference. In this case, a high absolute value of the loss function can mean that a parameter of the model needs to undergo a strong change.

In the case of a scalar output, a loss function may be a difference metric such as an absolute value of a difference, a squared difference.

In the case of vector-valued outputs, for example, difference metrics between vectors such as the root mean square error, a cosine distance, a norm of the difference vector such as a Euclidean distance, a Chebyshev distance, an Lp-norm of a difference vector, a weighted norm or any other type of difference metric of two vectors can be chosen. These two vectors may for example be the desired output (target) and the actual output.

In the case of higher dimensional outputs, such as two-dimensional, three-dimensional or higher-dimensional outputs, for example an element-wise difference metric may for example be used. Alternatively or additionally, the output data may be transformed, for example to a one-dimensional vector, before computing a loss value.

The machine learning model according to the present disclosure is configured to receive input data of different modalities. Usually, there are different inputs for inputting input data of different modalities, e.g., an image input for inputting one or more images, a text input for inputting one or more texts (including numbers), and/or an audio input for inputting one or more audio files.

The machine learning model comprises at least two inputs, a first input and a second input, and at least three outputs, a first output, a second output and a third output.

In some embodiments, the first input is configured to receive the first masked input data, and the second input is configured to receive the second masked input data. The first output serves to reconstruct first augmented input data from first masked input data; the second output serves to reconstruct second augmented input data from second masked input data. The third output serves to generate a joint representation of the first masked input data and the second masked input data.

With a varying number of k modalities, the model usually has k inputs and k+1 outputs, with k being an integer greater than 1. In other word: in case input data of 2 different modalities are inputted into the machine learning model for training purposes, there are usually 2 inputs, and 2+1=3 outputs; in case input data of 3 different modalities are inputted into the machine learning model for training purposes, there are usually 3 inputs, and 3+1=4 outputs.

The machine learning model is configured to receive multimodal input data and generate a multimodal representation of the object, at least partially on the basis of the input data and model parameters.

If input data of different modalities are inputted into the machine learning model, the machine learning model is configured to generate a joint representation of the input data of the different modalities. If, for example, the set of input data comprises first input data of a first modality (e.g., an image) and second input data of a second modality (e.g., a text), then the machine learning model generates a joint representation of the first input data and the second input data.

A joint representation generated by the machine learning model is characterized by the fact that input data from different modalities are merged into one another.

The model is taught to generate multimodal representations of objects based on multimodal input data (and to merge input data of different modalities into one another) in a training procedure described herein.

The multimodal representation of an object generated by the machine learning model can be a vector, or a matrix or a tensor or the like. Usually, the multimodal representation of an object generated by the machine learning model is of lesser dimension than the dimension of the input data from which the representation is generated. In other words: when generating a multimodal representation of an object on the basis of input data related to the object, the machine learning model extracts information from the input data which is suited to represent the object for the purposes described herein; the extraction of information is usually accompanied by a dimensional reduction.

During training of the machine learning model, first masked input data is inputted into the first input and the machine learning model is trained to reconstruct the first augmented input data from the first masked input data via the first output (first reconstruction task).

In addition, second masked input data is inputted into the second input and the machine learning model is trained to reconstruct the second augmented input data from the second masked input data via the second output (second reconstruction task).

In addition, the machine learning model is trained to generate a joint representation from the first masked input data inputted into the first input and the second masked input data inputted into the second input, and to discriminate joint representations which originate from the same input data from joint representations which do not originate from the same input data but from different input data (discrimination task).

If a further set of input data is available (such as third input data), the machine learning model is trained to perform an additional reconstruction task (e.g., a third reconstruction task). In addition, the machine learning model is trained to generate a joint representation from all masked input data inputted into the inputs and to discriminate joint representations which originate from the same input data from joint representations which do not originate from the same input data but from different input data.

During training, parameters of the machine learning model are modified in a way that improves the reconstruction quality and the discrimination quality. This can be done by computing one or more loss values—the loss value(s) indicating the quality of the task(s) performed—and modifying parameters of the machine learning model so that the loss value(s) is/are minimized.

For each reconstruction task, a reconstruction loss can be computed, e.g., a first reconstruction loss Lᵣ¹ for the first reconstruction task, and a second reconstruction loss Lᵣ², for the second reconstruction task. The mean square error (MSE) between input and output can be used as objective function for the proxy task of the reconstructions. Furthermore, Huber loss, cross-entropy and other functions can be used as objective function for the proxy task of reconstructions.

For the discrimination task, a contrastive loss L_{c} can be computed. Such contrastive loss can be the normalized temperature-scaled cross entropy (NT-Xent) (see, e.g., T. Chen et al.: “A simple framework for contrastive learning of visual representations”, arXiv preprint arXiv:2002.05709, 2020, in particular equation (1)). Further details about contrastive learning can also be found in: P. Khosla et al.: Supervised Contrastive Learning, Computer Vision and Pattern Recognition; arXiv:2004.11362; J. Dippel, S. Vogler, J, Mime: Towards Fine-grained Visual Representations by Combining Contrastive Learning with Image Reconstruction and Attention-weighted Pooling, arXiv:2104.04323v1).

The training loss L_{T} (total loss) can be the sum of the reconstruction losses and the contrastive loss. In case of two reconstruction tasks and one discrimination task the training loss L T can be calculated by the following equation:

L_{T}=α·Lᵣ¹+β·Lᵣ²+γ·L_{c}

in which α, β, and γ are weighting factors which can be used to weight the losses, e.g., to give to a certain loss more weight than to another loss. α, β, and γ can be any value greater than zero; for example, α, β, and γ can represent a value greater than zero and smaller or equal to one. In case of α=β=γ=1, each loss is given the same weight. Note, that α, β, and γ can vary during the training process. It is for example possible to start the training process with giving greater weight to the contrastive loss than to the reconstruction loss, and, once the machine learning model has gained a pre-defined accuracy in performing the discrimination task, complete the training with giving greater weight to one or both (or more in case of data of more than two modalities) reconstruction task(s).

In a preferred embodiment of the present disclosure, the machine learning model is or comprises a deep neural network. A deep neural network is a biologically inspired computational model. Such a deep neural network usually comprises at least three layers of processing elements: a first layer with input neurons, an Nth layer with at least one output neuron, and N−2 inner layers, where N is a natural number greater than 2. In such a network, the input neurons serve to receive the input data. If the input data constitutes or comprises an image, there is usually one input neuron for each pixel/voxel of the input image; there can be additional input neurons for additional input data such as data about the object represented by the input image, the type of image, the way the image was acquired and/or the like. The output neurons serve to output one or more values, e.g., a reconstructed image, a score, a regression result and/or others.

The processing elements of the layers are interconnected in a predetermined pattern with predetermined connection weights therebetween. Each network node represents a (simple) calculation of the weighted sum of inputs from prior nodes and a non-linear output function. The combined calculation of the network nodes relates the inputs to the outputs.

The training can be performed with a set of training data comprising input data of a multitude of objects.

When trained, the connection weights between the processing elements contain information regarding the relationship between the input data and the output data.

Each network node can represent a calculation of the weighted sum of inputs from prior nodes and a non-linear output function. The combined calculation of the network nodes relates the inputs to the outputs.

The network weights can be initialized with small random values or with the weights of a prior partially trained network. The training data inputs are applied to the network and the output values are calculated for each training sample. The network output values can be compared to the target output values. A backpropagation algorithm can be applied to correct the weight values in directions that reduce the error between calculated outputs and targets. The process is iterated until no further reduction in error can be made or until a predefined prediction accuracy has been reached.

A cross-validation method can be employed to split the data into training and validation data sets. The training data set is used in the error backpropagation adjustment of the network weights. The validation data set is used to verify that the trained network generalizes to make good predictions. The best network weight set can be taken as the one that presumably best predicts the outputs of the test data set. Similarly, varying the number of network hidden nodes and determining the network that performs best with the data sets optimizes the number of hidden nodes.

In a preferred embodiment, the deep neural network is or comprises a convolutional neural network (CNN). A CNN is a class of deep neural networks, most commonly applied to, e.g., analyzing visual imagery. A CNN comprises an input layer with input neurons, an output layer with at least one output neuron, as well as multiple hidden layers between the input layer and the output layer.

The hidden layers of a CNN typically comprise convolutional layers, ReLU (Rectified Linear Units) layers, i.e. z activation function, pooling layers, fully connected layers and normalization layers.

The nodes in the CNN input layer can be organized into a set of “filters” (feature detectors), and the output of each set of filters is propagated to nodes in successive layers of the network. The computations for a CNN include applying the mathematical convolution operation with each filter to produce the output of that filter. Convolution is a specialized kind of mathematical operation performed with two functions to produce a third function. In convolutional network terminology, the first function of the convolution can be referred to as the input, while the second function can be referred to as the convolution kernel. The output may be referred to as the feature map. For example, the input of a convolution layer can be a multidimensional array of data that defines the various color components of an input image. The convolution kernel can be a multidimensional array of parameters, where the parameters are adapted by the training process for the neural network.

The objective of the convolution operation is to extract features (such as, e.g., edges from an input image). Conventionally, the first convolutional layer is responsible for capturing the low-level features such as edges, color, gradient orientation, etc. With added layers, the architecture adapts to the high-level features as well, giving a network which has the wholesome understanding of images in the dataset. Similar to the convolutional layer, the pooling layer is responsible for reducing the spatial size of the feature maps. It is useful for extracting dominant features with some degree of rotational and positional invariance, thus maintaining the process of effectively training of the model. Adding a fully-connected layer is a way of learning non-linear combinations of the high-level features as represented by the output of the convolutional part.

The deep neural network is trained to reconstruct the first augmented input data from the first masked input data and output such reconstructed first augmented input data via the first output layer. Additionally, the deep neural network is trained to reconstruct the second augmented input data from the second masked input data and output such reconstructed second augmented input data via the second output layer. Additionally, the deep neural network is trained to generate a joint representation of the input data (the first and second masked input data), and to discriminate joint representations which originate from the same object from joint representations which originate from different objects.

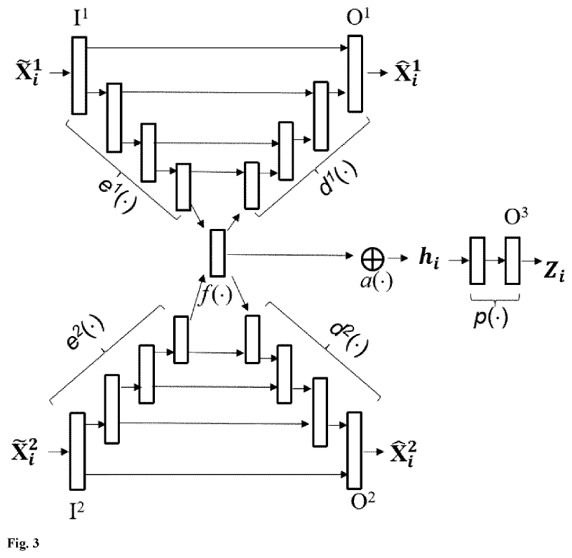

FIG. 3 shows schematically a preferred embodiment of the architecture of the deep neural network according to the present disclosure. The architecture of the deep neural network can be divided into seven components. The deep neural network comprises a first encoder e1(⋅), a first decoder d1(⋅), a second encoder e2(⋅), a second decoder d2(⋅), a fusion component f(⋅), an attention weighted pooling a(⋅) and a projection head p(⋅).

Note, FIG. 3 shows an example of the architecture of a deep neural network which can be used to learn multimodal representations of data of two different modalities. If representations of data of three different modalities are to be generated by a deep neural network, such a deep neural network can comprise a third encoder and a third decoder. All encoders are merged into one embedding: the joint representation of the different input data of different modality.

The aim of the encoders is to generate a joint representation (embedding) of the multimodal input data. The aim of the decoders is to reconstruct unmasked data from the joint representation. The projection head serves to map the joint representation to a space where contrastive loss is applied. The projection head can, e.g., be a multi-layer perceptron with one hidden ReLU layer (ReLU: Rectified Linear Unit).

In the training process, the network receives:
first masked input data \tilde{X}ᵢ¹ via input layer I¹, and
second masked input data \tilde{X}ᵢ² via input layer I²,
   and the model outputs:
reconstructed first augmented input data \hat{X}ᵢ²=d¹(f(e¹(Xᵢ¹),(e²(Xᵢ²))) via output layer O¹,
reconstructed second augmented input data Xᵢ²d²(f(e¹(\tilde{X}ᵢ¹),e²(\tilde{X}ᵢ²))) via output layer O², and
contrastive representation Zᵢ=p(a(f(e¹(\tilde{X}ᵢ¹),e²(\tilde{X}ᵢ²))) via output layer O³.

Function f(⋅) is the fusion component that combines the representation of the two (or more) modalities into one joint representation. The fusion can be done by first concatenating the vectors e¹(\tilde{X}ᵢ¹) and e²(\tilde{X}ᵢ²), and then performing convolution operations on the concatenated representation.

For the encoder and decoder of the deep neural network, various backbones can be used such as the U-net (see, e.g., O. Ronneberger et al.: U-net: Convolutional networks for biomedical image segmentation, in: International Conference on Medical image computing and computer-assisted intervention, pp. 234-241, Springer, 2015, https://doi.org/10.1007/978-3-319-24574-4_28) or the DenseNet (see, e.g., G. Huang et al.: “Densely connected convolutional networks”, IEEE Conference on Computer Vision and Pattern Recognition, 2017, pp. 2261-2269, doi: 10.1109/CVPR.2017.243.).

Once trained, the projection head p(⋅), and the decoders d1(⋅), d2(⋅) can be discarded and the remaining neural network comprising the two encoders e1(⋅), e2(⋅) and the attention pooling a( ) can be used to generate joint representations of multimodal input data with hᵢ=a(f(e₁(\tilde{X}ᵢ¹),e²(Xᵢ²))).

Based on such a trained neural network other more complex tasks can be solved, e.g., classification. To that end, a classification head is added. This classification head can be a neural network, a linear classifier, a random forest, a support vector machine or another decision algorithm.

In one example, the trained neural network receives, e.g., two sets of input data, a first set of a first modality and a second set of a second modality. The trained neural network can generate a joint representation form the input data and the joint representation can be fed into a classification head. The classification head classifies the joint representation into one of two classes, a first class comprising joint representations which are based on input data originating from the same object, and a second class comprising joint representations which are based on input data originating from different objects.

Such a classifier is schematically depicted in FIG. 4. The classifier comprises a first input I1 for receiving input data Xₘ¹ of a first modality, the input data representing an object m. The classifier comprises a second input I2 for receiving input data Xₙ² of a second modality, the input data representing an object n. The classifier comprises a first encoder e1(⋅), a second encoder e2(⋅) and an attention pooling a(⋅) which together generate a joint representation hᵢ of the input data. The classifier comprises a classification head c(⋅) which classifies joint representations into one of two classes, a first class comprising joint representations which are based on first and second input data originating from the same object (m=n), and a second class comprising joint representations which are based on first and second input data originating from different objects (min).

One potential application for such a classifier is the assessment of whether two sets of input data of different modality belong to the same object. In case the object is a patient, and the input data are patient data of different modality, such as a medical image and patient data in text form, the classifier can be used to check whether the medical image relates to the patient data in text form or vice versa.

In case a medical image is generated from a patient, the medical image together with patient data in text form can be inputted into the classifier and the output of the classifier can be used to determine whether there is any mistake, e.g. in the sense that the medical image is of such a quality that it needs to be renewed or in the sense that the medical image does not show what is expected (from what is known about the patient from the patient data in text form) or in the sense that there has been a mix-up (e.g. the patient from which a medical image is generated is not the one from which it should have been generated).

Hence, in a further aspect, the present invention provides a computer-implemented method of assessing whether two sets of input data of different modality relate to each other, the method comprising:
receiving input data of at least two different modalities, first input data of a first modality and second input data of a second modality,
providing a machine learning model, the model comprising
   a first input,
   a second input,
   a first encoder for the first input data, a second encoder for the second input data and an attention pooling, wherein the first encoder, the second encoder and the attention pooling are configured to generate a joint representation of the first input data and the second input data,
   a classification head which is configured to receive the joint representation and to classify the joint representation into one of two classes, a first class and a second class, the first class comprising joint representations which were generated from first and second input data originating from the same object and the second class comprising joint representations which were generated from first and second input data originating from different objects,
inputting the first input data into the first input of the machine learning model,
inputting the second input data into the second input of the machine learning model,
receiving from the machine learning model an information whether the first input data and the second input data belong to the same object,
outputting the information.

The operations in accordance with the teachings herein may be performed by at least one computer system specially constructed for the desired purposes or at least one general-purpose computer system specially configured for the desired purpose by at least one computer program stored in a typically non-transitory computer readable storage medium.

The term “non-transitory” is used herein to exclude transitory, propagating signals or waves, but to otherwise include any volatile or non-volatile computer memory technology suitable to the application.

A “computer system” is a system for electronic data processing that processes data by means of programmable calculation rules. Such a system usually comprises a “computer”, that unit which comprises a processor for carrying out logical operations, and also peripherals.

In computer technology, “peripherals” refer to all devices which are connected to the computer and serve for the control of the computer and/or as input and output devices. Examples thereof are monitor (screen), printer, scanner, mouse, keyboard, drives, camera, microphone, loudspeaker, etc. Internal ports and expansion cards are, too, considered to be peripherals in computer technology.

Computer systems of today are frequently divided into desktop PCs, portable PCs, laptops, notebooks, netbooks and tablet PCs and so-called handhelds (e.g., smartphone); all these systems can be utilized for carrying out the invention.

The term “process” as used above is intended to include any type of computation or manipulation or transformation of data represented as physical, e.g., electronic, phenomena which may occur or reside e.g., within registers and/or memories of at least one computer or processor. The term processor includes a single processing unit or a plurality of distributed or remote such units.

Any suitable input device, such as but not limited to a camera sensor, may be used to generate or otherwise provide information received by the system and methods shown and described herein. Any suitable output device or display may be used to display or output information generated by the system and methods shown and described herein. Any suitable processor/s may be employed to compute or generate information as described herein and/or to perform functionalities described herein and/or to implement any engine, interface or other system described herein. Any suitable computerized data storage, e.g., computer memory may be used to store information received by or generated by the systems shown and described herein. Functionalities shown and described herein may be divided between a server computer and a plurality of client computers. These or any other computerized components shown and described herein may communicate between themselves via a suitable computer network.

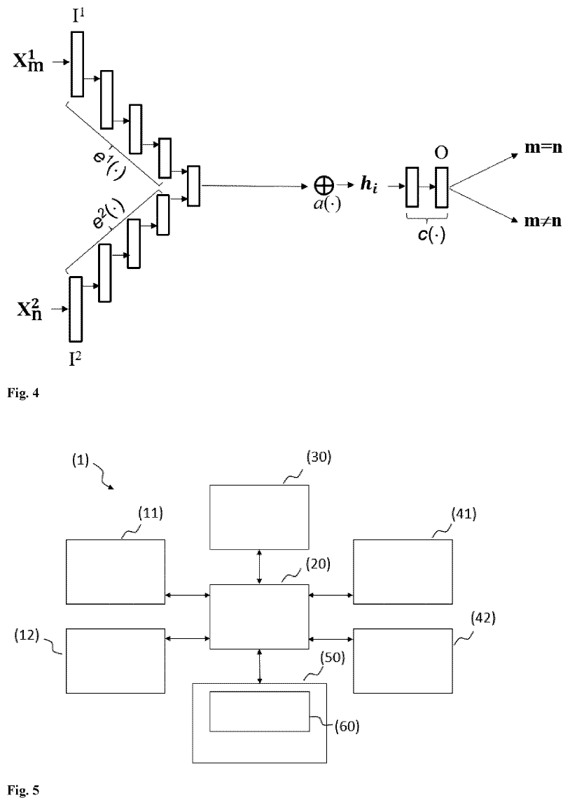

FIG. 5 illustrates a computer system (1) according to some example implementations of the present disclosure in more detail.

Generally, a computer system of exemplary implementations of the present disclosure may be referred to as a computer and may comprise, include, or be embodied in one or more fixed or portable electronic devices. The computer may include one or more of each of a number of components such as, for example, processing unit (20) connected to a memory (50) (e.g., storage device).

The processing unit (20) may be composed of one or more processors alone or in combination with one or more memories. The processing unit is generally any piece of computer hardware that is capable of processing information such as, for example, data, computer programs and/or other suitable electronic information. The processing unit is composed of a collection of electronic circuits some of which may be packaged as an integrated circuit or multiple interconnected integrated circuits (an integrated circuit at times more commonly referred to as a “chip”). The processing unit may be configured to execute computer programs, which may be stored onboard the processing unit or otherwise stored in the memory (50) of the same or another computer.

The processing unit (20) may be a number of processors, a multi-core processor or some other type of processor, depending on the particular implementation. Further, the processing unit may be implemented using a number of heterogeneous processor systems in which a main processor is present with one or more secondary processors on a single chip. As another illustrative example, the processing unit may be a symmetric multi-processor system containing multiple processors of the same type. In yet another example, the processing unit may be embodied as or otherwise include one or more ASICs, FPGAs or the like. Thus, although the processing unit may be capable of executing a computer program to perform one or more functions, the processing unit of various examples may be capable of performing one or more functions without the aid of a computer program. In either instance, the processing unit may be appropriately programmed to perform functions or operations according to example implementations of the present disclosure.

The memory (50) is generally any piece of computer hardware that is capable of storing information such as, for example, data, computer programs (e.g., computer-readable program code (60)) and/or other suitable information either on a temporary basis and/or a permanent basis. The memory may include volatile and/or non-volatile memory and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk—read/write (CD-R/W), DVD, Blu-ray disk or the like. In various instances, the memory may be referred to as a computer-readable storage medium. The computer-readable storage medium is a non-transitory device capable of storing information and is distinguishable from computer-readable transmission media such as electronic transitory signals capable of carrying information from one location to another. Computer-readable medium as described herein may generally refer to a computer-readable storage medium or computer-readable transmission medium.

In addition to the memory (50), the processing unit (20) may also be connected to one or more interfaces for displaying, transmitting and/or receiving information. The interfaces may include one or more communications interfaces and/or one or more user interfaces. The communications interface(s) may be configured to transmit and/or receive information, such as to and/or from other computer(s), network(s), database(s) or the like. The communications interface may be configured to transmit and/or receive information by physical (wired) and/or wireless communications links. The communications interface(s) may include interface(s) (41) to connect to a network, such as using technologies such as cellular telephone, Wi-Fi, satellite, cable, digital subscriber line (DSL), fiber optics and the like. In some examples, the communications interface(s) may include one or more short-range communications interfaces (42) configured to connect devices using short-range communications technologies such as NFC, RFID, Bluetooth, Bluetooth LE, ZigBee, infrared (e.g., IrDA) or the like.

The user interfaces may include a display (30). The display may be configured to present or otherwise display information to a user, suitable examples of which include a liquid crystal display (LCD), light-emitting diode display (LED), plasma display panel (PDP) or the like. The user input interface(s) (11) may be wired or wireless and may be configured to receive information from a user into the computer system (1), such as for processing, storage and/or display. Suitable examples of user input interfaces include a microphone, image or video capture device, keyboard or keypad, joystick, touch-sensitive surface (separate from or integrated into a touchscreen) or the like. In some examples, the user interfaces may include automatic identification and data capture (AIDC) technology (12) for machine-readable information. This may include barcode, radio frequency identification (RFID), magnetic stripes, optical character recognition (OCR), integrated circuit card (ICC), and the like. The user interfaces may further include one or more interfaces for communicating with peripherals such as printers and the like.

As indicated above, program code instructions may be stored in memory, and executed by processing unit that is thereby programmed, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, processing unit or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processing unit or other programmable apparatus to configure the computer, processing unit or other programmable apparatus to execute operations to be performed on or by the computer, processing unit or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

Execution of instructions by processing unit, or storage of instructions in a computer-readable storage medium, supports combinations of operations for performing the specified functions. In this manner, a computer system (1) may include processing unit (20) and a computer-readable storage medium or memory (50) coupled to the processing circuitry, where the processing circuitry is configured to execute computer-readable program code (60) stored in the memory. It will also be understood that one or more functions, and combinations of functions, may be implemented by special purpose hardware-based computer systems and/or processing circuitry which perform the specified functions, or combinations of special purpose hardware and program code instructions.

1. A computer-implemented method of training a machine learning model, the method comprising:
receiving, for each object of a multitude of objects, input data comprising first input data of a first modality and second input data of a second modality;
generating first augmented input data from the first input data and second augmented input data from the second input data;
generating first masked input data from the first augmented input data and second masked input data from the second augmented input data;
providing a machine learning model, the machine learning model comprising:
a first input,
a second input,
a first output,
a second output, and
a third output,
training the machine learning model to perform a combined reconstruction and discrimination task, the training comprising:
inputting the first masked input data into the first input,
inputting the second masked input data into the second input,
reconstructing the first augmented input data from the first masked input data via the first output,
reconstructing the second augmented input data from the second masked input data via the second output,
generating a joint representation of the first masked input data and the second masked input data via the third output, and
discriminating joint representations which were generated from input data of the same object from joint contrastive representations which were generated from input data of different objects; and
storing and/or outputting the trained machine learning model and/or providing the trained machine learning model for predictive purposes.

2. The method of claim 1, wherein the first input data of the first modality comprises, for each object, one or more images of the object or a part of the object.

3. The method of claim 2, wherein the first augmented input data are generated from the first input data by applying one or more image augmentation techniques to the first input data, wherein the one or more image augmentation techniques comprise one or more of the following techniques: rotation, elastic deformation, flipping, scaling, stretching, shearing, cropping and/or resizing.

4. The method of claim 2, wherein the first masked input data are generated from the first augmented input data by applying one or more masking techniques to the first augmented input data, wherein the one or more masking techniques comprise one or more of the following techniques: random or non-random cutouts, and/or random or non-random erasing s.

5. The method of claim 1, wherein the object is a living object, preferably a human being, or a part thereof.

6. The method of claim 1, wherein the object is a crop or a collection of crops or an agricultural field or a part of the Earth's surface.

7. The method of claim 1, wherein the second input data of the second modality comprise, for each object, text data.

8. The method of claim 7, wherein the second augmented input data are generated from the second input data by applying one or more text augmentation techniques to the second input data, wherein the one or more text augmentation techniques comprise one or more of the following techniques: adding and/or replacing and/or removing content, in particular letters, numbers, words, tokens, and/or phrases.

9. The method of claim 7, wherein the second masked input data are generated from the second augmented input data by applying one or more masking techniques to the second augmented input data, wherein the one or more masking techniques comprise one or more of the following techniques: random or non-random cutouts and/or replacements of letters, numbers, words, tokens, and/or phrases.

10. The method of claim 1, wherein the machine learning model comprises a deep neural network, the deep neural network comprising a first encoder e¹(⋅), a first decoder d¹(⋅), a second encoder e²(⋅), a second decoder d²(⋅), a fusion component f(⋅), an attention weighted pooling a(⋅), and a projection head p(⋅).

11. The method of claim 1, wherein the machine learning model comprises a deep neural network, wherein training of the deep neural network comprises, for each object, the steps of:
inputting first masked input data \tilde{X}ᵢ¹ via the first input, and second masked input data \tilde{X}ᵢ² via the second input,
outputting reconstructed first augmented input data \hat{X}ᵢ¹=d¹(f(e¹(\tilde{X}ᵢ¹),e²(\tilde{X}ᵢ²))) via the first output,
outputting reconstructed second augmented input data \hat{X}ᵢ²=d²(f(e¹(\tilde{X}ᵢ¹)e²(Xᵢ²))) via the second output, and
outputting joint contrastive representation Zᵢ=p(a(f(e¹(\tilde{X}ᵢ¹),e²(\tilde{X}ᵢ²))) via the third output.

12. The method of claim 1, wherein training of the machine learning model is steered by a training loss L_{T}, the loss L_{T} comprising three parts: a reconstruction loss Lᵣ¹ for the reconstruction of the data of first modality, a reconstruction loss Lᵣ², for the reconstruction of the data of second modality, and a contrastive loss L_{c}:
L_{T}=α·Lᵣ¹+β·Lᵣ²+γ·L_{c}
wherein α, β and γ are weighting factors.

13. A computer system comprising:
a processor; and
a memory storing an application program configured to perform, when executed by the processor, an operation for training a machine learning model, the operation comprising:
receiving, for each object of a multitude of objects, input data comprising first input data of a first modality and second input data of a second modality,
generating first augmented input data from the first input data and second augmented input data from the second input data,
generating first masked input data from the first augmented input data and second masked input data from the second augmented input data,
providing a machine learning model, the machine learning model comprising:
a first input;
a second input;
a first output;
a second output; and
a third output,
training the machine learning model to perform a combined reconstruction and discrimination task, the training comprising:
inputting the first masked input data into the first input;
inputting the second masked input data into the second input;
reconstructing the first augmented input data from the first masked input data via the first output;
reconstructing the second augmented input data from the second masked input data via the second output;
generating a joint representation of the first masked input data and the second masked input data via the third output; and
discriminating joint representations which were generated from input data of the same object from joint contrastive representations which were generated from input data of different objects, and
storing and/or outputting the trained machine learning model and/or providing the trained machine learning model for predictive purposes.

14. A non-transitory computer readable medium storing instructions that, when executed by a processor of a computer system, cause the computer system to:
receive, for each object of a multitude of objects, input data comprising first input data of a first modality and second input data of a second modality;
generate first augmented input data from the first input data and second augmented input data from the second input data;
generate first masked input data from the first augmented input data and second masked input data from the second augmented input data;
provide a machine learning model, the machine learning model comprising:
a first input,
a second input,
a first output,
a second output, and
a third output;
train the machine learning model to perform a combined reconstruction and discrimination task, the training comprising:
inputting the first masked input data into the first input,
inputting the second masked input data into the second input,
reconstructing the first augmented input data from the first masked input data via the first output,
reconstructing the second augmented input data from the second masked input data via the second output,
generating a joint representation of the first masked input data and the second masked input data via the third output, and
discriminating joint representations which were generated from input data of the same object from joint contrastive representations which were generated from input data of different objects; and
store and/or output the trained machine learning model and/or providing the trained machine learning model for predictive purposes.

15. A computer-implemented method of assessing whether two sets of input data of different modalities relate to each other, the method comprising:
receiving input data comprising first input data of a first modality and second input data of a second modality;
providing a machine learning model, the model comprising:
a first input,
a second input,
a first encoder for the first input data, a second encoder for the second input data and an attention pooling, wherein the first encoder, the second encoder and the attention pooling are configured to generate a joint representation of the first input data and the second input data, and
a classification head which is configured to receive the joint representation and to classify the joint representation into one of two classes, a first class and a second class, the first class comprising joint representations which were generated from first and second input data originating from the same object and the second class comprising joint representations which were generated from first and second input data originating from different objects;
inputting the first input data into the first input of the machine learning model;
inputting the second input data into the second input of the machine learning model; and
receiving from the machine learning model an information whether the first input data and the second input data belong to the same object;
outputting the information,
wherein the machine learning model was trained using the method of claim 1.
